(19) United States
(12) Patent Application Publication
(10) Pub. No.: US 2008/0079984 A1
(43) Pub. Date: Apr. 3, 2008

(54) Digital Image Sharing

(76) Inventor: Frank V. Gallucci, Webster, NY (US)

Correspondence Address: JAECKLE FLEISCHMANN & MUGEL, LLP, 190 Linden Oaks, ROCHESTER, NY, 14625-2812, US

(21) Appl. No.: 11/534,491

(22) Filed: Sep. 22, 2006

(51) Int. Cl. G06F 3/12

(52) U.S. Cl. 358/1.15

(57) ABSTRACT

A digital image sharing system has a server, a receiving device configured to communicate with the server, and a sending device configured to communicate with the server and the receiving device. The sending device sends at least one digital image to the server, the digital image being stored on the server and identified by an image identifier. The sending device communicates the image identifier to the receiving device. The receiving device uses the image identifier to retrieve the at least one digital image from the server.

### FIELD

The claimed invention generally relates to digital image sharing systems. More particularly, the claimed invention relates to digital image sharing systems and methods which enable a sender to store digital images on a server, send an image identifier for the stored digital images to a recipient, and have the recipient be able to retrieve the stored digital images without sending the recipient's email address to the server.

### BACKGROUND

As a result of the current digital and communications revolution, more and more people are generating digital images which they would like to share with other people. Once digital images are resident on a device, they may be sent directly to other devices and/or recipients using email or instant messaging. Often, the digital images being sent are very large compared with the space and size limitations which can be placed on email and instant messaging communication servers. As a result, emails or instant messages with large attached digital images can be undeliverable, slow, and/or tie-up a recipients mailbox.

One solution to this problem has been to upload the large digital images from a sending device to a server along with an email address of the intended recipient. The server then sends an email with a Universal Resource Locator (URL, aka web link) within the email to a recipient device. A user of the recipient device can then click on the URL to download the digital image outside of the email pipeline, and therefore avoiding bogging down the email system. While this solution alleviates some issues, it unfortunately creates new issues. First, by providing the server with the recipient's email address, the operators of the server can easily capture that address to give or sell to other parties or even use themselves for the purposes of advertising and/or spamming the owner of the recipient email address. In order to combat this, many recipients will install spam blocking and/or email filtering software which can learn to block such unwanted email. Unfortunately, this can also create a second issue, since legitimate emails containing a URL link to shared digital images may also be blocked by the spam filtering software.

Therefore, there exists a need for a digital image sharing system which allows users to share large digital images without tying up electronic mailboxes and without exposing the recipient's email address to pyshing (and therefore possible spam) from a server and/or companies which the server might do business with.

### SUMMARY

A digital image sharing system has a server, a receiving device configured to communicate with the server, and a sending device configured to communicate with the server and the receiving device. The sending device sends at least one digital image to the server, the digital image being stored on the server and identified by an image identifier. The sending device communicates the image identifier to the receiving device. The receiving device uses the image identifier to retrieve the at least one digital image from the server.

A method of digital image sharing from a sending device is also shown. At least one digital image is stored on a server. An image identifier is generated for the at least one digital image. The image identifier is incorporated into a communication. The communication is sent from the sending device to a receiving device. The communication is received at the receiving device. The at least one digital image stored on the server is retrieved using the image identifier on the receiving device.

### BRIEF DESCRIPTION OF THE DRAWINGS

FIG. 1 schematically illustrates an embodiment of a network of electronic devices.

FIG. 2 schematically illustrates an embodiment of a digital image sharing system.

FIGS. 3A-3B schematically illustrate embodiments of the digital image sharing system of FIG. 2.

FIG. 4 illustrates one embodiment of a method of sharing digital images over a network.

### DETAILED DESCRIPTION

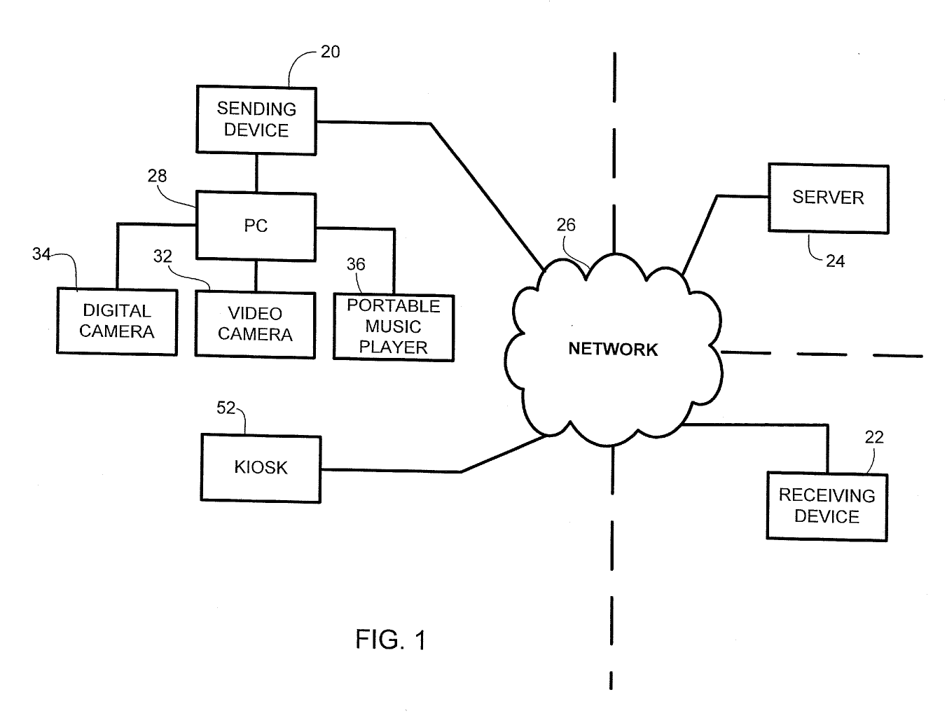

FIG. 1 schematically illustrates an embodiment of a network of electronic devices which is an example of an environment which may be used to practice the claimed invention. At a very basic level, the environment has a sending device 20, a receiving device 22, and a server 24 which are communicatively coupled together by a network 26. The network 26 can be a communications environment incorporating any wired, optical, wireless, or combination thereof method of data communication. One example of a typical network is a wide area network (WAN) such as the internet. Various network 26 configurations are known to those skilled in the art, or may be developed by those skilled in the art for the purpose of allowing communication between sending device 20 and the server 24, between sending device 20 and the receiving device 22, and between receiving device 22 and the server 24. All such network connections and any protocols necessary to effect such communications are considered to be within the scope of this disclosure.

Sending device 20 may encompass many types of devices which capture, store, manipulate, use, and/or generate digital images. One example of a sending device is a personal computer 28 which may be connected to the network 26. Personal computer 28 may have one or more processors for executing instructions, memory and storage devices such as random access memory (RAM), read only memory (ROM), a hard drive, a floppy drive, a compact disc drive, a DVD drive, an optical drive, a magnetic drive, a memory card reader and/or memory cards, at least one communications bus for communicating data between elements of the computer, input and output ports for connection to peripherals, communications devices, and input devices such as a keyboard and a mouse, output devices such as displays and monitors, an operating system for executing instructions on the processor, and software for running applications on the computer. The personal computer 28 may also be a laptop. Personal computers 28 are well-known in the art and come in various configurations. The personal computer is capable of communicating with the network 26. Occasionally, the personal computer 28 will have sending devices attached to it, such as a video camera 32, digital camera 34, and/or a portable music player 36. These sending devices may be used to communicate with the network 26 via the personal computer 28 which is coupled to the network 26. In other embodiments, devices such as the video camera 32, digital camera 34, and the portable music player 36 may be connected directly to the network 26, depending on their configurations. Connections to the network for these devices and others may be accomplished through any wired, optical, wireless, or combination thereof method. It is also possible to have a kiosk 52 as a sending device 20. A kiosk 52 may include storage media readers and/or communications interfaces for importing digital images into the kiosk 52 for further actions. The kiosk 52 may process the digital images before sharing information on the network or simply be a conduit to the network 26.

Examples of receiving devices 22 may include, but are not limited to all of the examples of sending devices 20. For simplicity, these example devices are not shown in FIG. 1, since they have already been discussed.

The server 24 may be a computer or a distributed set of computers and/or storage devices which communicate with the network 26.

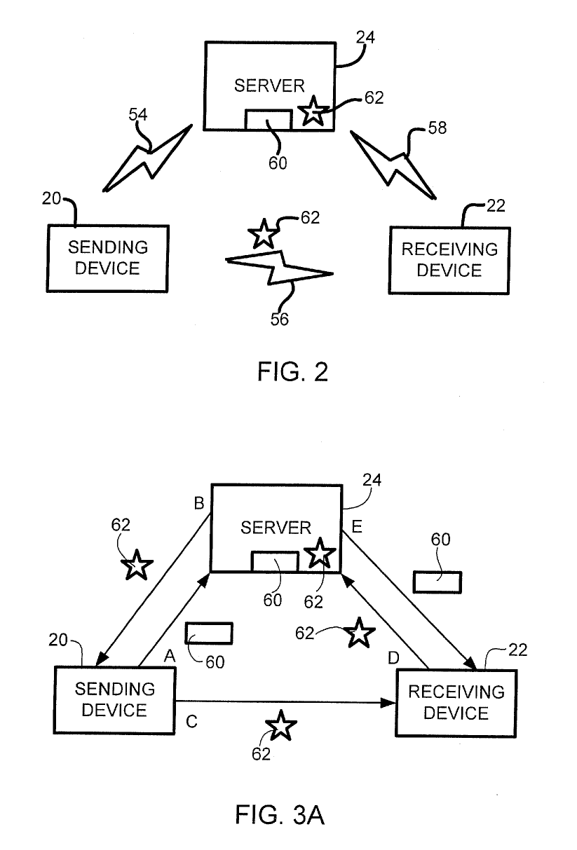

FIG. 2 schematically illustrates an embodiment of a digital image sharing system. The sending device 20 is configured to communicate 54 with server 24. The sending device 20 is also configured to communicate 56 with receiving device 22. The receiving device 22 is further configured to communicate 58 with the server 24. The communications 54, 56, and 58 between devices 20, 22, and 24 can be thought of as data signals, embodied in a propagation medium such as the air, wires, and/or fiber optics. The communication propagation medium is not critical to the claimed invention, and therefore is shown generically in the figures.

The sending device 20 sends at least one digital image 60 on the server 24, the digital image 60 being stored on the server and identified by an image identifier 62. The sending device 20 communicates the image identifier 62 to the receiving device 22. The receiving device 22 uses the image identifier 62 to retrieve the at least one digital image 60 from the server 24. This interaction between the receiving device 22 and the server 24 does not require the server 24 to know the email address of the receiving device 22 or any other identifying information about the receiving device 22. This has the advantage of protecting the identity of the receiving device 22 from physhing and spamming. In some embodiments, the image identifier 62 may be a URL.

In the embodiment of FIG. 2, as well as other embodiments, the server 24 may simply store the digital image 60 for retrieval by the receiving device 22, or it may be configured to modify the digital image as a service to the sending device 20 and/or the receiving device 22.

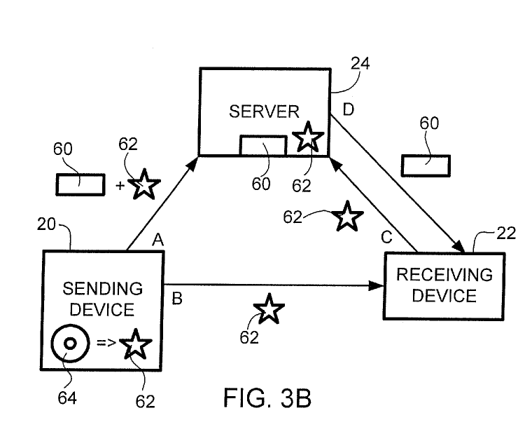

FIG. 3A schematically illustrates an embodiment of the digital image sharing system of FIG. 2. The sending device 20 sends (A) the digital image 60 to the server 24. This may be done in various ways, including, but not limited to uploading the digital image 60 via a web interface using a browser resident on the sending device 20; sending the digital image 60 to the server 24 using an email generated on the sending device 20 and attaching the digital image 60 to the email; or running a program or a plug-in on the sending device 20 which has the capability to interact with the server 24 for at least the purposes of digital image transfer. The server 24 stores the digital image 60 and generates and stores an associated image identifier 62. The server 24 returns (B) at least the image identifier 62 to the sending device 20, for example, via a web interface, via email, or via some other program running on the sending device 20. The image identifier 62 can be, for example, a URL, an identification number, an identification name created by the user, or any combination thereof. The sending device 20 then sends (C) at least the image identifier 62 to the receiving device 22. Methods of sending the image identifier 62 can include, but are not limited to, email. The server 24 can also send other information to the sending device 20 besides the image identifier 62. This information can contain formatting information, or can even be a form email which was generated at least in part by the server 24. Once the receiving device 22 has the image identifier 62, it can use (D) the image identifier 62 to retrieve the at least one digital image 60 from the server 24. This interaction can include, for example, retrieving (E) the digital image 60 for display and/or storing the digital image 60 on the receiving device, or ordering prints of the digital images. This interaction on the receiving device 22 can be accomplished via a web browser or an active element in an email or instant message which, for example, can retrieve a digital image for display in an email. The interaction can also be accomplished via a specially designed piece of software installed on the receiving device 22 for the purpose of an interaction.

FIG. 3B schematically illustrates another embodiment of the digital image sharing system of FIG. 2. The sending device 20 has a software program 64 which generates an image identifier 62 on the sending device 23. The image identifier 62 can be, for example, a URL, an identification number, an identification name created by the user, or any combination thereof. The sending device 20 then sends (A) the digital image 60 and the image identifier 62 to the server 24. This may be done in various ways, including, but not limited to uploading the digital image 60 and the image identifier 62 via a web interface using a browser resident on the sending device 20; sending the digital image 60 and the image identifier 62 to the server 24 using an email generated on the sending device 20 and attaching the digital image 60 and the image identifier 62 to the email; or running a program or a plug-in on the sending device 20 which has the capability to interact with the server 24 for at least the purposes of digital image 60 and image identifier 62 transfer. The server 24 stores the digital image 60 and the associated image identifier 62. The sending device 20 then sends (B) at least the image identifier 62 to the receiving device 22. Methods of sending the image identifier 62 can include, but are not limited to, email. Once the receiving device 22 has the image identifier 62, it can use (C) the image identifier 62 to retrieve the at least one digital image 60 on the server 24. This interaction can include, for example, retrieving (D) the digital image 60 for display, or storing the digital image 60 on the receiving device 22. This interaction on the receiving device 22 can be accomplished via a web browser or an active element in an email. The interaction can also be accomplished via a specially designed piece of software installed on the receiving device 22 for the purpose of an interaction.

Features of the above embodiments may be interchanged, and substitutions and modifications will be apparent to those skilled in the art in light of the descriptions. Such substitutions, changes, and modifications are intended to be within the scope of this disclosure and the appended claims. For example, where software is referenced, it should be apparent that firmware, digital or analog electronics, application specific integrated circuits (ASICs), other processors, other software, and/or any combination thereof may be used to implement a digital image sharing system. Furthermore, although one digital image 60 has been referenced for simplicity, the system will work equally well with multiple digital images, whether one image identifier 62 is assigned to a set of digital images, or each digital image in a set of digital images receives its own image identifier 62. The server 24 has been illustrated as a single entity, but the server 24 may be a distributed entity in other embodiments. As another example, although a single receiving device 22 has been shown, the sending device 20 may communicate the image identifier 62 to more than one receiving device 22 at the same time.

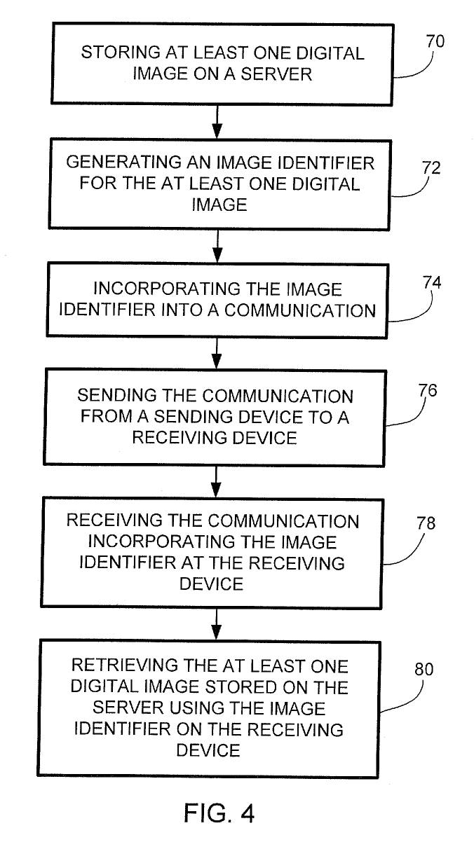

FIG. 4 illustrates one embodiment of a method of sharing digital images over a network. At least one digital image is stored 70 on a server. An image identifier is generated 72 for the at least one digital image. The image identifier is incorporated 74 into a communication. The communication is sent 76 from a sending device to a receiving device. The communication incorporating the image identifier is received 78 at the receiving device. The at least one digital image stored on the server is retrieved 80 using the image identifier on the receiving device.

The digital image sharing system has many advantages, which have been discussed above. Included in those benefits are the protection of the identity, including the email address, of the receiving device from the server. There is no need with this digital image sharing system to provide the server with the email address of the recipient. This offers higher security against physhing (the culling of email addresses), helps cut down on spam, and helps prevent issues with spam filters on the receiving device.

Having thus described several embodiments of the claimed invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A digital image sharing system, comprising
a server;
a receiving device configured to communicate with the server;
a sending device configured to communicate with the server and the receiving device; and
wherein:
the sending device sends at least one digital image to the server, the digital image being stored on the server and identified by an image identifier;
the sending device communicates the image identifier to the receiving device; and
the receiving device uses the image identifier to retrieve the at least one digital image from the server.

2. The digital image sharing system of claim 1, wherein the image identifier is generated by the server and communicated to the sending device when the sending device stores at least one digital image on the server.

3. The digital image sharing system of claim 2, wherein the image identifier comprises a URL.

4. The digital image sharing system of claim 2, wherein the image identifier comprises an identification number.

5. The digital image sharing system of claim 1, wherein the image identifier is generated by the sending device and communicated to the server when the sending device stores at least one digital image on the server.

6. The digital image sharing system of claim 1, wherein the image identifier is generated by an interaction between the sending device and the server when the sending device stores at least one digital image on the server.

7. The digital image sharing system of claim 1, wherein the sending device is configured to communicate with the server by email.

8. The digital image sharing system of claim 1, wherein the sending device is configured to communicate with the server using an FTP link.

9. The digital image sharing system of claim 1, wherein the sending device is configured to communicate with the server using a web interface.

10. The digital image sharing system of claim 1, wherein the sending device communicates the image identifier to the receiving device using an email, generated on the sending device, containing the image identifier.

11. The digital image sharing system of claim 1, wherein the sending device communicates the image identifier to the receiving device using an email comprising a form email generated at least in part by the server.

12. The digital image sharing system of claim 1, wherein the receiving device uses the image identifier to retrieve the at least one digital image on the server by browsing to the at least one digital image.

13. A method of digital image sharing from a sending device, comprising:
storing at least one digital image on a server;
generating an image identifier for the at least one digital image;
incorporating the image identifier into a communication;
sending the communication from the sending device to a receiving device;
receiving the communication at the receiving device; and
retrieving the at least one digital image stored on the server using the image identifier on the receiving device.

14. The method of claim 13, wherein the generation of the image identifier for the at least one digital image is performed by the server.

15. The method of claim 13, wherein the generation of the image identifier for the at least one digital image is performed by the sending device.

16. The method of claim 13, wherein the generation of the image identifier for the at least one digital image is performed by a combination of the sending device and the server.

17. The method of claim 13, wherein incorporating the identifier into a communication comprises creating a form email at the server and sending that form email to the sending device.

18. The method of claim 13, wherein incorporating the image identifier into a communication comprises creating an email message on the sending device.

19. The method of claim 18, wherein creating the email message on the sending device comprises automatically inserting the image identifier into the email message.

20. The method of claim 13, wherein the image identifier comprises a URL.

21. The method of claim 13, wherein the image identifier comprises an identification number.

22. A set of machine executable instructions embodied on a machine readable medium for sharing digital images, comprising:
instructions enabling a sending device to send and store at least one digital image on a server;
instructions enabling the sending device to create an image identifier associated with the at least one digital image; and
instructions enabling the sending device to communicate the image identifier with a receiving device.

23. A set of machine executable instructions embodied on a machine readable medium for sharing digital images, comprising:
instructions enabling a sending device to send and store at least one digital image on a server;
instructions enabling the server to create an image identifier associated with the at least one digital image; and
instructions enabling the sending device to communicate the image identifier with a receiving device.

24. A set of machine executable instructions embodied on a machine readable medium for sharing digital images, comprising:
instructions enabling a sending device to send and store at least one digital image on a server;
instructions enabling a combination of the server and the sending device to create an image identifier associated with the at least one digital image; and
instructions enabling the sending device to communicate the image identifier with a receiving device.
